(19) United States
(12) Patent Application Publication
(10) Pub. No.: US 2010/0070680 A1
(43) Pub. Date: Mar. 18, 2010

(54) MEMORY MANAGEMENT METHOD DURING POWER-ON SELF TEST

(75) Inventors: Peng-Fang LUO, Shanghai City (CN); Yin DENG, Shanghai City (CN); Chih-Feng CHEN, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/265,830

(22) Filed: Nov. 6, 2008

(30) Foreign Application Priority Data
Sep. 12, 2008 (TW) 097135191

(51) Int. Cl. G06F 12/00

(52) U.S. Cl. 711/102

(57) ABSTRACT

A memory management method during a power-on self test is used to perform an access management on an option ROM during a power-on self test after a personal computer is powered on. The memory management method includes the following steps. When a BIOS is booted, an option ROM is detected. A memory segment is designated in a conventional memory. It is determined whether the memory segment is empty or not. If the memory segment is not empty, a register segment with the same capacity as the memory segment is applied for from an extended memory, and data in the memory segment is moved to the register segment for being stored. If the memory segment is empty, data in the option ROM is moved to the memory segment. The option ROM in the memory segment is set.

### CROSS-REFERENCE TO RELATED APPLICATIONS

This non-provisional application claims priority under 35 U.S.C. §119(a) on Patent Application No(s). 097135191 filed in Taiwan, R.O.C. on Sep. 12, 2008 the entire contents of which are hereby incorporated by reference.

### BACKGROUND OF THE INVENTION

1. Field of the Invention

The present invention relates to a memory management method, and more particularly to a memory management method for an option read only memory (ROM) during a power-on self test after a personal computer is powered on.

2. Related Art

In order to drive operations of a computer device, a basic input/output system (BIOS) is loaded before the computer device begins operating. The BIOS is mainly used for communicating with drivers for the lower layer hardware of each component on the motherboard. In terms of functions, the BIOS includes three parts: a power-on self test (POST) and initialization program, a hardware interrupt process, and a program service request.

The POST and initialization program part is in charge of booting a computer, including three parts. The first part is used for detecting the hardware when the computer is just powered on, and is also referred to as POST, which aims at checking whether the computer is in a normal state or not. Usually, a complete POST includes tests on a central processing unit (CPU), a basic memory of 640K bytes, extended memories of over 1M bytes, a ROM, a motherboard, a complementary metal-oxide-semiconductor (CMOS) memory, serial/parallel ports, a display card, a floppy/hard disc, and a key board. Once a problem is detected during the POST, the system gives hint information or a beep alarm. If an error is detected during the POST, it is processed according to the following two situations. If a severe fault occurs, the computer is powered off, and no hint or signal is given since the initialization is not accomplished; when a non-severe fault occurs, a hint or alarming signal is given for prompting the user to take measurements.

The second part of the POST and initialization program is initialization, and includes creating an interrupt vector, setting a register, initializing and detecting some peripheral devices, among which the most important part is the settings of the BIOS. Particularly, some parameters for the hardware are set, the parameters are read when the computer is booted, and then the parameters are compared with the practical hardware settings. If the parameters fail to comply with the practical settings, the booting of the system is affected. The last part of the POST and initialization program is a bootstrap program, which is used for booting DOS or other operating systems. The BIOS starts to read a bootstrap record from a start sector of the floppy disc or the hard disc, if no bootstrap record is found, it is displayed on the display that no bootstrap equipment is found; otherwise, if the bootstrap record is found, the control right on the computer is transferred to the bootstrap record, and the operating system is loaded into the computer through the bootstrap record. After the computer is booted successfully, this part of the BIOS function is finished.

During the POST process, a POST memory manager applies for a space for running the option ROM from the system. However, a common option ROM usually occupies a memory space of about 10K bytes, so that the system may search for a corresponding space from the conventional memory and designate the space to the option ROM that requires the space. If an option ROM exceeds 256K bytes, it is difficult for the system to find out an available space from the conventional memory for storing the option ROM. FIG. 1 is a schematic view of a conventional memory segment.

### SUMMARY OF THE INVENTION

In view of the aforementioned problems, the present invention is mainly directed to an option ROM management method, which is adapted to perform an access management on an option ROM during a power-on self test after a personal computer is powered on.

In order to achieve the above objective, the present invention provides a memory management method, which includes the following steps. When a basic input/output system (BIOS) is booted, the option ROM is detected. A memory segment is designated in a conventional memory. It is determined whether the memory segment is empty or not. If the memory segment is not empty, a register segment is applied for from an extended memory, and data in the memory segment is moved to the register segment for being stored. The memory segment is freed up to offer an available space for running an option ROM configuration. The option ROM executes the option ROM configuration. Data stored in the memory segment is recovered by using the data in the register segment.

A memory application form in a POST memory manager is adjusted to reserve a sufficient memory space for running the option ROM and to protect data in the memory space, such that the POST memory manager can apply for the memory segment from the BIOS so as to offer sufficient space for running the option ROM. Meanwhile, after the option ROM stops running, the original operations are canceled, and the BIOS maintains unchanged, so as to ensure the integrity of the original BIOS.

### BRIEF DESCRIPTION OF THE DRAWINGS

The present invention will become more fully understood from the detailed description given herein below for illustration only, and thus is not limitative of the present invention, and wherein:

FIG. 1 is a schematic view of a conventional memory segment;

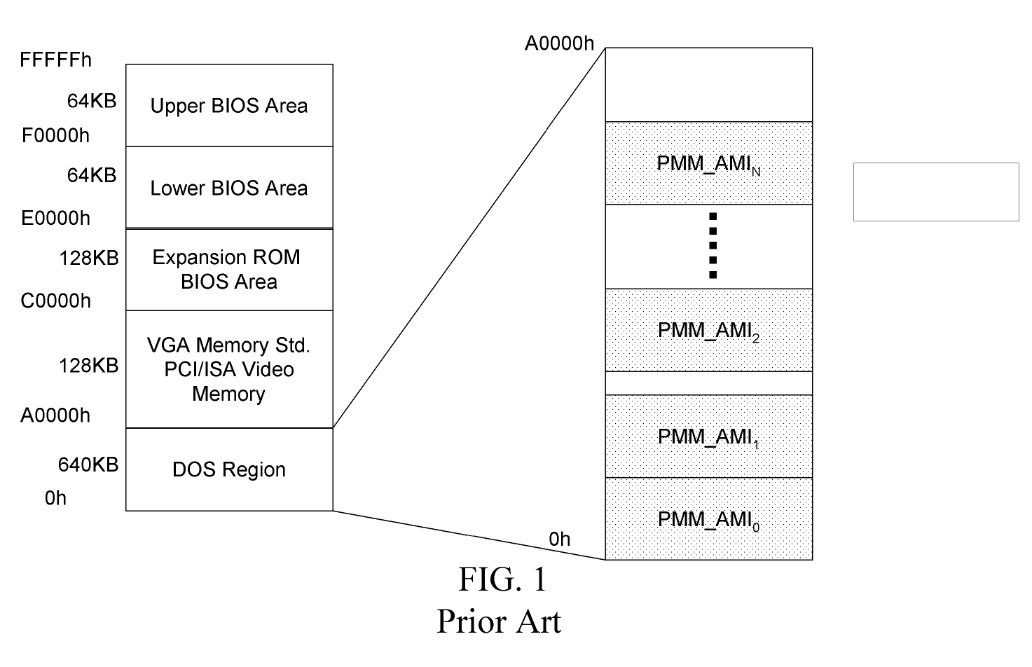

FIG. 2 is a system architecture view of the present invention;

FIG. 3 is a flow chart of an operation of the present invention;

FIG. 4A is a schematic view of setting a marking tag;

FIG. 4B is a schematic view of moving to a register segment; and

FIG. 4C is a schematic view of moving to a memory segment.

### DETAILED DESCRIPTION OF THE INVENTION

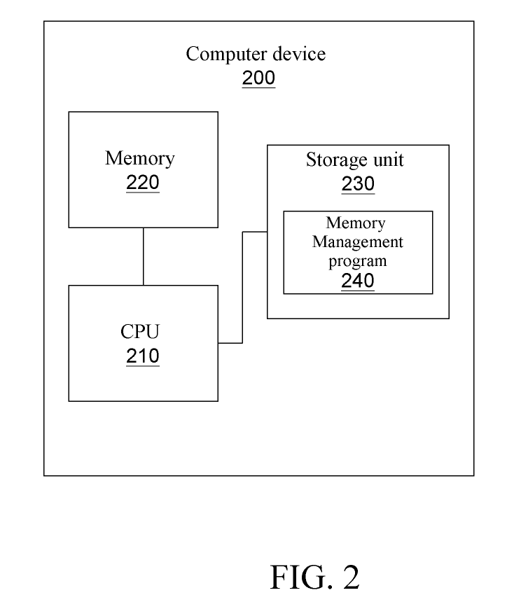

FIG. 2 is a system architecture view of the present invention. The present invention is applied to a basic input/output system (BIOS) of a computer device for implementing an access management of an option ROM. Referring to FIG. 2, a computer device 200 includes: a CPU 210, a memory 220, a storage unit 230, and a memory management program 240. The CPU 210 is electrically connected to the memory 220 and the storage unit 230. The storage unit 230 is used for storing the memory management program 240. The CPU 210 is used to execute the memory management program 240 before running the power-on self test (POST).

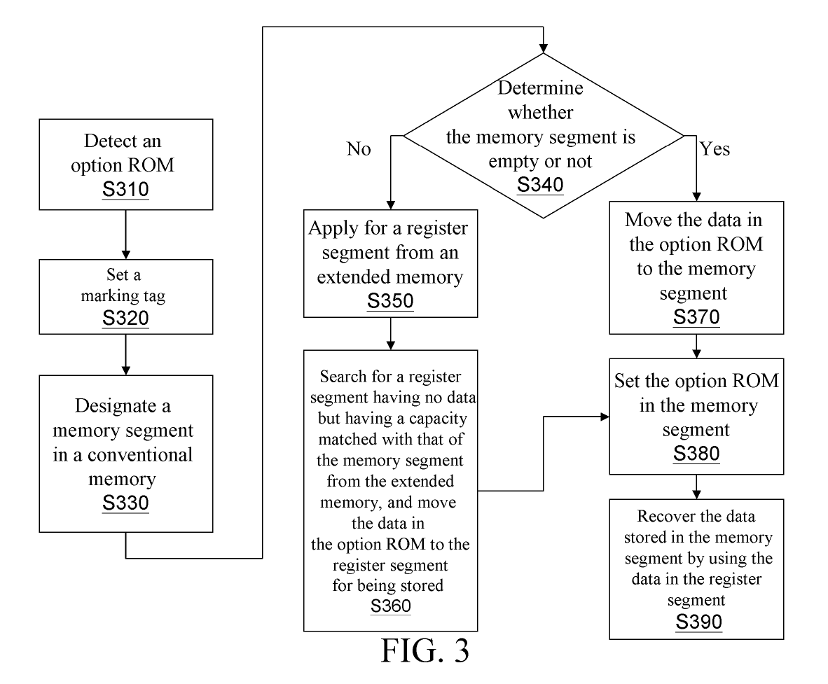

FIG. 3 is a flow chart of an operation of the present invention. Referring to FIG. 3, a step of executing the memory management program 240 includes the following steps. When the BIOS is booted, an option ROM is detected (Step S310). A marking tag is set (Step S320), for recording a start address of a memory segment of the option ROM. A memory segment is designated in a conventional memory (Step S330), in which the conventional memory has a capacity of about 640K bytes.

It is determined whether the memory segment is empty or not (Step S340). If the memory segment is not empty, a register segment is applied for from an extended memory (Step S350). The register segment has the same capacity as the memory segment, and data in the memory segment is moved to the register segment for being stored. A register segment having no data but having a capacity matched with that of the memory segment is searched for from the extended memory, and the data in the option ROM is moved to the register segment for being stored (Step S360).

If the memory segment is empty, the data in the option ROM is moved to the memory segment (Step S370). After that, the option ROM in the memory segment is set (Step S380). Finally, the data stored in the memory segment is recovered by using the data in the register segment (Step S390).

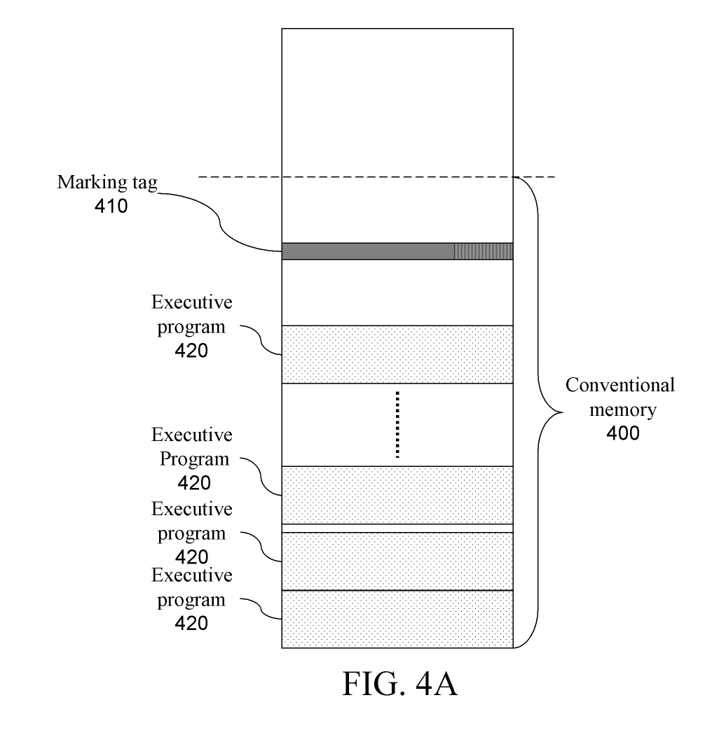

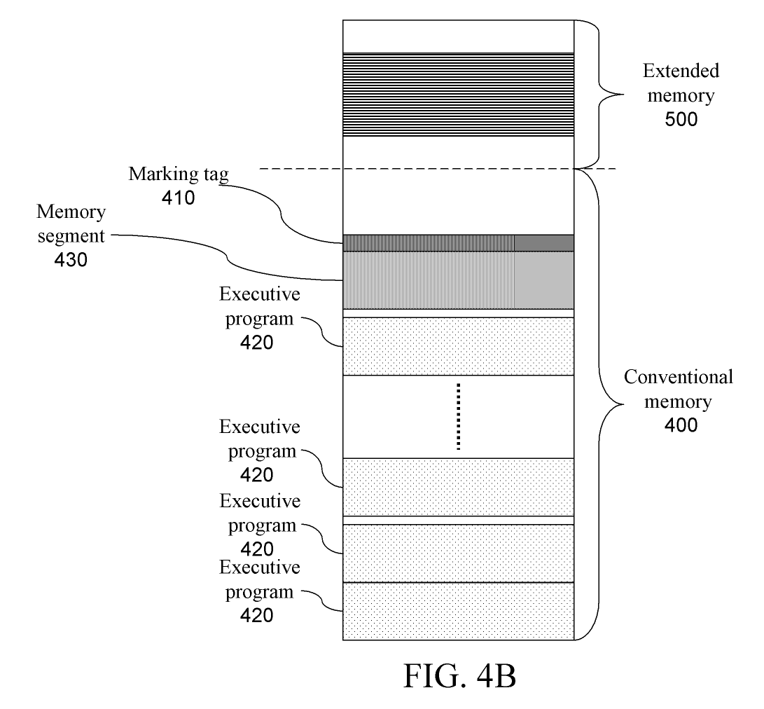

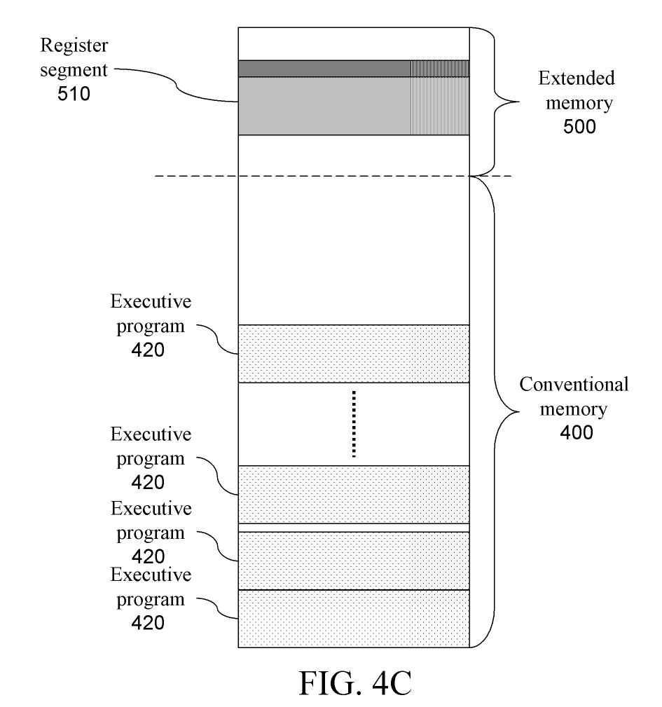

In order to clearly illustrate the sequence of the memory management operation in the present invention, it is illustrated below through an example. Firstly, the computer device 200 is booted, such that the CPU 210 starts to load the BIOS. Meanwhile, the CPU 210 starts to detect whether an option ROM needs to be loaded or not. A marking tag 410 is set to record a start address of the memory segment of the option ROM. FIG. 4A is a schematic view of setting a marking tag. In a memory configuration diagram shown in FIG. 4A, a plurality of executive programs 420 (shown by mesh-point sections in FIG. 4A) is included, and an area is selected from the conventional memory 400 that is not occupied by executive programs to set the marking tag 410.

Then, a memory segment 430 is designated in the conventional memory 400. If the memory segment 430 has already stored data, the CPU 210 applies for a register segment 510 having no data but having a capacity matched with that of the memory segment 430 from an extended memory 500. Moreover, the data in the option ROM is moved to the register segment 510 for being stored. FIG. 4B is a schematic view of moving to a register segment.

If the memory segment stores no data, the CPU 210 moves the data in the option ROM to the memory segment 430. FIG. 4C is a schematic view of moving to a memory segment. After the data in the option ROM has been moved, the CPU 210 sets the option ROM in the memory segment 430. Finally, the data stored in the memory segment 430 is recovered by using the data in the register segment 510.

In the present invention, a memory application form in a POST memory manager is adjusted to reserve a sufficient memory space for running the option ROM and to protect data in the memory space, such that the POST memory manager can apply for the memory segment from the BIOS so as to offer sufficient space for running the option ROM. Meanwhile, after the option ROM stops running, the original operations are canceled, and the BIOS maintains unchanged, so as to ensure the integrity of the original BIOS.

What is claimed is:

1. A memory management method during a power-on self test, adapted to manage a memory space required for running an option ROM configuration during a power-on self test after a computer is powered on, the memory management method comprising:
designating a memory segment in a conventional memory;
determining whether the memory segment is empty or not;
applying for a register segment from an extended memory and moving the data in the memory segment to the register segment for being stored, when the memory segment is not empty;
freeing up the memory segment to offer a space for running the option ROM configuration;
executing the option ROM configuration; and
recovering the data stored in the memory segment by using the data in the register segment.

2. The memory management method during a power-on self test according to claim 1, wherein before designating the memory segment, the method further comprises:
detecting the option ROM, when a basic input/output system (BIOS) is booted.

3. The memory management method during a power-on self test according to claim 1, wherein a capacity of the memory segment has 640K bytes.

4. The memory management method during a power-on self test according to claim 1, wherein before designating the memory segment, the method further comprises: setting a marking tag, for recording a start address of the memory segment.

5. The memory management method during a power-on self test according to claim 4, wherein after recovering the memory segment, the method further comprises: freeing up the marking tag.

6. The memory management method during a power-on self test according to claim 1, wherein the step of applying for the register segment from the extended memory further comprises:
searching for a register segment having no data but having a capacity matched with that of the memory segment from the extended memory, wherein the register segment has the same capacity as the memory segment.

7. The memory management method during a power-on self test according to claim 1, wherein the step of recovering the data stored in the memory segment further comprises:
moving the data in the register segment to the memory segment; and
freeing up the register segment.

8. The memory management method during a power-on self test according to claim 1, wherein when the memory segment is empty, the option ROM configuration is executed.
